(19) United States
(12) Patent Application Publication
(10) Pub. No.: US 2026/0331770 A1
(43) Pub. Date: Oct. 22, 2026

(54) Single-substrate coplanar coupling wide-band high-accuracy positioning combined antenna

(71) Applicant: Huizhou Ruixin Wireless Technology Co., Ltd., Huizhou, GD (CN)

(72) Inventor: Yunsu Ling, Huizhou, GD (CN)

(21) Appl. No.: 18/993,921

(22) PCT Filed: Oct. 31, 2023
(86) PCT No.: PCT/CN2023/128383

§ 371 Date: Jan. 13, 2025

(30) Foreign Application Priority Data
Jun. 30, 2023 (CN) 202310797987.3
Oct. 19, 2023 (CN) 202311362087.2

(51) Int. Cl. H01Q 5/20; H01Q 9/04

(52) U.S. Cl. CPC H01Q 5/20; H01Q 9/0407

(57) ABSTRACT

A single-substrate coplanar coupling wide-band high-accuracy positioning combined antenna. This antenna comprises: a substrate plate, a GNSS patch attached to the surface of the substrate plate, and multiple feeding holes; the GNSS antenna assembly includes a first metal radiating unit and a second metal radiating unit surrounding the first metal radiating unit; a first non-metallized isolating region is provided between the first metal radiating unit and the second metal radiating unit; the first non-metallized isolating region is provided with multiple first metallized coupling bridges; the two ends of each first metallized coupling bridge are electrically connected to the first metal radiating unit and the second metal radiating unit, respectively; furthermore, the first metal radiating unit, the second metal radiating unit, the first non-metallized isolating region, and the multiple first metallized coupling bridges are all symmetrically arranged around the center of the first metal radiation unit.

### FIELD OF THE INVENTION

The present invention relates to the technical field of antenna. Particularly, to a single-substrate coplanar coupling wide-band high-accuracy positioning combined antenna.

### BACKGROUND OF THE INVENTION

With the rapid development of the global navigation satellite system (GNSS), the utilization of wideband antennas has increased significantly for each system. Taking the Beidou navigation system as an example, it offers high-precision positioning, with independent frequencies required for both the transmission and reception of short messages. Besides fulfilling high-precision positioning, Beidou navigation system also caters to the transmission and reception of short messages.

Traditional stacked GNSS antenna technology typically necessitates two or more layers, resulting in an increase in antenna size, number of layers, thickness, and cost. This approach makes it increasingly challenging to meet the current requirements. For example, Chinese patent No.: CN112290205A discloses a miniaturized combined antenna. The GNSS antenna comprises: a first layer of substrate; a first radiating patch, attached to the upper surface of the first layer of substrate, the first radiating patch is provided with a feeding point to form one of a first radiating unit or a second radiating unit; a feeding pin, electrically connected to the feeding point; a second layer of substrate, arranged on the lower surface of the first layer of substrate; a second radiating patch, the second radiating patch is set between the lower surface of the first layer of substrate and the upper surface of the second layer of substrate, the second radiating patch is provided with a coupling hole, the feeding pin extends into the coupling hole from the feeding point, a gap is formed between the inner wall surface of the coupling hole and the feeding pin so that the second radiating patch is coupled to form the other one of the first radiating unit or the second radiating unit; and a reference ground, the reference ground is attached to the lower surface of the second layer of substrate, the reference ground is electrically connected with the first radiating patch and the second radiating patch, in order to realize the grounding of the first radiating patch and the second radiating patch; When the first and second radiating units are designed for different frequencies, the greater the number of frequency bands utilized by the GNSS, the more overlapping layers there will be. This results in increased thickness, which necessitates a higher feeding pin. However, an excessively high feeding pin can cause signal loss and interference, leading to performance degradation. To mitigate signal loss and interference, it becomes necessary to reduce the thickness of each layer. As the thickness is reduced, the antenna's gain and bandwidth are significantly decreased.

Therefore, there is a need for a combined antenna to replace a conventional stacked antenna. Such an antenna can meet the requirements of multi-system compatibility, wide frequency band, and the precision standards of modern applications without adding to the overall thickness or even aiming for a reduction in the total thickness of the antenna.

### SUMMARY

The invention aims to provide a single-substrate coplanar coupling broadband antenna with high-accuracy positioning, addressing the technical challenge of how the total thickness of composite antennas affects wide-band signal output in current technology.

To achieve the aforementioned objective, the present invention embodies a single-substrate coplanar coupling wide-band high-accuracy positioning combined antenna. This antenna comprises: a substrate plate, a GNSS patch attached to the surface of the substrate plate, and multiple feeding holes.

The GNSS antenna assembly includes a first metal radiating unit and a second metal radiating unit surrounding the first metal radiating unit. A first non-metallized isolating region is provided between the first metal radiating unit and the second metal radiating unit. The first non-metallized isolating region is provided with multiple first metallized coupling bridges. The two ends of each first metallized coupling bridge are electrically connected to the first metal radiating unit and the second metal radiating unit, respectively. Furthermore, the first metal radiating unit, the second metal radiating unit, the first non-metallized isolating region, and the multiple first metallized coupling bridges are all symmetrically arranged around the center of the first metal radiation unit.

Preferably, each feeding hole is positioned on either the first metal radiating unit or the second metal radiating unit specifically for the purpose of outputting GNSS high or low frequency coupling signals.

Preferably, the first metal radiation unit and the second metal radiation unit are both provided with multiple feeding holes for outputting GNSS high or low-frequency coupling signals.

Preferably, the third metal radiating unit is disposed around the second metal radiating unit, and a second non-metallized isolating region is disposed between the second metal radiating unit and the third metal radiating unit. The second non-metallized isolating region is provided with multiple second metallized coupling bridges, the two ends of the second metallized coupling bridge are electrically connected with the second metal radiating unit and the third metal radiating unit, respectively.

Preferably, the third metal radiating unit and the second non-metallized isolating region are symmetrically arranged with the center of the first metal radiating unit.

Preferably, the substrate plate and the first metal radiating unit are both equipped with metallized central through-holes that can be aligned and interconnected. These central through-holes are electrically connected to the bottom surface of the substrate plate via metallized grounding or PCB grounding.

Preferably, the substrate plate is provided with multiple metallized grounding holes, and each of the metallized grounding holes is disposed around the GNSS antenna assembly. The metallized ground hole is electrically connected with the back surface of the substrate plate via metallized grounding or PCB grounding.

Preferably, the metallized grounding hole extends to form a metallized grounding down-conversion branch, which is located on the substrate plate for down-conversion processing of the GNSS antenna assembly.

Preferably, multiple mobile communication antennas are strategically distributed around the metallized grounding down-conversion branch.

Preferably, multiple metallized isolating grooves are strategically positioned around GNSS antenna assembly and are electrically connected to the bottom surface of the substrate plate.

The above one or more technical solutions in the single-substrate coplanar coupled wide-band high-precision positioning combined antenna provided by the embodiment of the present invention have at least one of the following technical effects:

In the invention, a single-substrate coplanar coupling wide-band high-accuracy positioning combined antenna comprises a substrate plate, a GNSS patch, and a plurality of feeding holes. The GNSS antenna assembly is fixed on the upper surface of the PCB plate. Each feeding hole is located on the GNSS antenna assembly. The GNSS antenna assembly is composed of a first metal radiating unit, a second metal radiating unit, and a plurality of feeding holes. Both the first metal radiating unit and the second metal radiating unit are symmetrically arranged with the centre of the first metal radiating unit, and the second metal radiating unit is disposed around the first metal radiating unit. The first non-metallized isolating region is provided between the first metal radiating unit and the second metal radiating unit, and the first non-metallized isolation region is also symmetrically arranged with the center of the first metal radiation unit. Several first metallized coupling bridges are provided on the first non-metallized isolating region at intervals, the first metallized coupling bridges are symmetrically arranged with the centre of the first metal radiating unit. Each feeding hole is respectively set on the first metal radiating unit or the second metal radiating unit, or each feeding hole is set on the first metal radiating unit and the second metal radiating unit at the same time. Through the above structure, with the action of the metallized coupling bridge, the GNSS antenna assembly couples with two or more than two wide-band GNSS radio frequency signals of the central frequency, and outputs them to the PCB input through the PIN pins, thus to realize the function of wide-band GNSS signal reception.

### BRIEF DESCRIPTION OF THE DRAWINGS

In order to clearly illustrate the technical solutions in the embodiments of the present invention, the drawings to be used in the Description of the embodiments or the existing technologies will be briefly described below, and it will be apparent that the drawings described below are only some embodiments of the present invention, and for those of ordinary skill in the art, other attached drawings can be obtained according to these attached drawings without creative labour.

FIG. 1 shows a perspective of the single-substrate coplanar coupling wide-band high-accuracy positioning combined antenna according to an embodiment of the present invention.

FIG. 2 shows another perspective of the single-substrate coplanar coupling wide-band high-accuracy positioning combined antenna according to an embodiment of the present invention.

FIG. 3 shows another perspective of the single-substrate coplanar coupling wide-band high-accuracy positioning combined antenna according to an embodiment of the present invention.

FIG. 4 shows another perspective of the single-substrate coplanar coupling wide-band high-accuracy positioning combined antenna according to an embodiment of the present invention.

FIG. 5 shows another perspective of the single-substrate coplanar coupling wide-band high-accuracy positioning combined antenna according to an embodiment of the present invention.

FIG. 6 shows another perspective of the single-substrate coplanar coupling wide-band high-accuracy positioning combined antenna according to an embodiment of the present invention.

FIG. 7 shows another perspective of the single-substrate coplanar coupling wide-band high-accuracy positioning combined antenna according to an embodiment of the present invention.

The reference Number are as follows:
10—the substrate plate;
11—the metallized central through hole
12—the metallized grounding hole;
14—the metallized isolating groove
13—the metallized grounding down-conversion branch;
15—the communication antennas;
20—the GNSS antenna assembly;
21—the first metal radiating unit;
22—the second metal radiating unit;
30—the feeding hole;
40—the first non-metallized isolating region;
41—the first metallized coupling bridge;
50—the second non-metallized isolating region;
51—the second metallized coupling bridge;
60—the third metal radiating unit.

### DETAILED DESCRIPTION OF ILLUSTRATED EMBODIMENTS

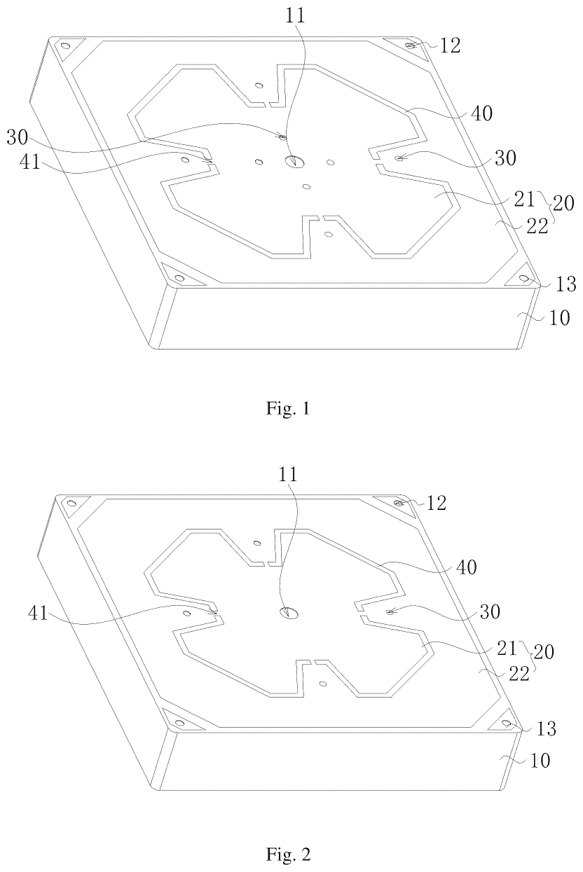

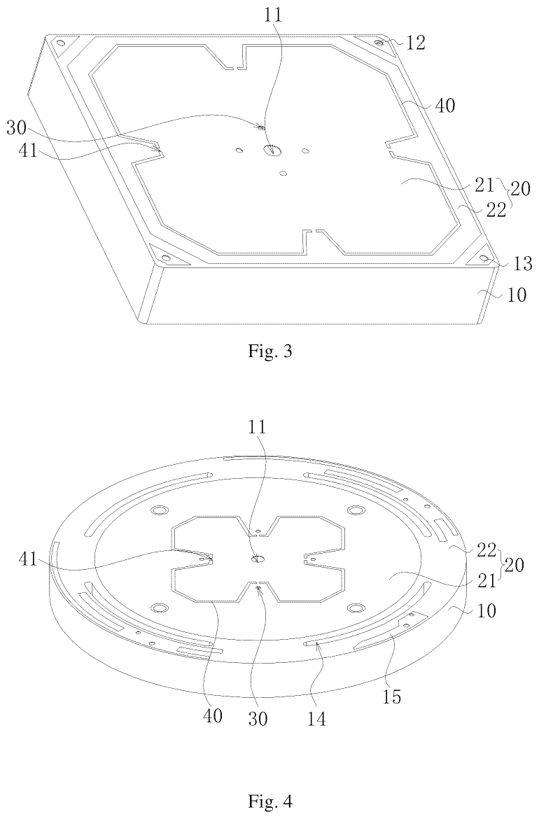

The embodiments of the present invention will be described in detail below, examples of which are shown in FIGS. 1-7, wherein the same or similar reference numbers throughout denote the same or similar elements or elements having the same or similar functions. The embodiments described below by reference to the accompanying drawings are exemplary and are intended to explain the embodiments of the present invention, and are not to be construed as a limitation of the invention.

In the description of embodiments of the present invention, it is to be understood that the terms “length”, “width”, “up”, “down ”, “front”, “back”, “left”, “right”, “vertical”, ‘horizontal’, ‘top’, ‘bottom’, “inner”, “outer” and the like indicate orientations or positional relationships based on those shown in the accompanying drawings, and are only intended to facilitate the description of the embodiments of the present invention and to simplify the description, and are not indicative of, or suggestive of, the fact that the device or element referred to must have a particular orientation, be constructed and operated in a particular orientation, and therefore cannot be construed as a limitation of the present invention.

In addition, the terms “first” and “second” are used only for the purpose of description, and are not to be understood as indicating or implying relative importance or implying the number of technical features indicated. As a result, the features defined “first” and “second” may include one or more such features explicitly or implicitly. In the Description of the embodiments of the present invention, “multiple” means two or more, unless otherwise specifically defined.

In the embodiments of the present invention, unless otherwise expressly specified and defined, the terms “installed”, “connected”, “connected”, “fixed” and so on should be broadly understood. For example, it may be a fixed connection, or may be a detachable connection, or may be an integrated connection; it can be mechanical connection or electric connection; It can be directly connected or indirectly connected through the intermediate substrate, and it can be a connection within two elements or an interaction between two elements. The specific meaning of the above terms in the embodiments of the present invention may be understood by those of ordinary skill in the art according to the specific circumstances.

In one embodiment of the present invention, referring to FIGS. 1-7, a single-substrate coplanar coupling wide-band high-accuracy positioning combined antenna includes a substrate plate 10, a GNSS antenna assembly 20 fixedly connected on the surface of the substrate plate 10, and a plurality of feeding holes 30. The GNSS antenna assembly 20 includes a first metal radiating unit 21 and a second metal radiating unit 22 surrounding the first metal radiating unit 21. A first non-metallized isolation region 40 is provided between the first metal radiating unit 21 and the second metal radiating unit 22. The first non-metallized isolating region 40 is provided with multiple first metallized coupling bridges 41. Two ends of each first metallized coupling bridge 41 are respectively electrically connected with the first metal radiating unit 21 and the second metal radiating unit 22. What more, the first metal radiating unit 21, the second metal radiating unit 22, the first non-metallized isolating region 40, and the multiple first metallized coupling bridges 41 are all arranged symmetrically about the center of the first metal radiation unit 21. And the first metal radiation unit 21 and the second metal radiation unit 22 are connected together by the first metallized coupling bridge 41.

A single-substrate coplanar coupling wide-band high-accuracy positioning combined antenna comprises a substrate plate 10, a GNSS antenna assembly 20, and a plurality of feeding holes 30. The GNSS antenna assembly 20 is fixed on the upper surface of the substrate plate 10. Each feeding hole 30 is located on the GNSS antenna assembly 20. The GNSS antenna assembly 20 is composed of a first metal radiating unit 21, a second metal radiating unit 22, and a plurality of feeding holes 30. Both the first metal radiating unit 21 and the second metal radiating unit 22 are symmetrically arranged with the centre of the first metal radiating unit 21, and the second metal radiating unit 22 is arranged around the first metal radiating unit 21. The first non-metallized isolating region 40 is provided between the first metal radiating unit 21 and the second metal radiating unit 22, and the first non-metallized isolation region 40 is also symmetrically arranged with the center of the first metal radiation unit 21. Several first metallized coupling bridges 41 are provided on the first non-metallized isolating region 40 at intervals, the first metallized coupling bridges 41 are symmetrically arranged with the centre of the first metal radiating unit 21. Each feeding hole 30 is respectively set on the first metal radiating unit 21 or the second metal radiating unit 22, or each feeding hole 30 is set on the first metal radiating unit 21 and the second metal radiating unit 22 at the same time. Through the above structure, with the action of the metallized coupling bridge, the GNSS antenna assembly 20 is coupled with two or more than two wide-band GNSS radio frequency signals of the central frequency, and is output to the PCB input end through the PIN pins so as to realize the function of receiving the wide-band GNSS signal.

In another embodiment of the present invention, as shown in FIGS. 1-7, the first metal radiation unit 21 and the second metal radiation unit 22 are both provided with a plurality of feeding holes 30 for outputting GNSS high-frequency or low-frequency coupling signals.

As shown in FIGS. 1, 3, and 5-6, there are two or four feeding holes 30 on the first metal radiating unit 21, and the distance between each feeding hole 30 on the first metal radiating unit 21 and the center of the first metal radiating unit 21 is equal. The included angle between the connecting lines, between the two adjacent feeding holes 30 on the first metal radiation units 21 and the center of the first metal radiating unit 21, is 90°.

As shown in FIGS. 1-2 and 6-7, there are two or four feeding holes 30 on the second metal radiating unit 22, and the distance between each feeding hole 30 on the second metal radiating unit 22 and the center of the first metal radiating unit 21 is equal, and the included angle between the connecting lines, between the two adjacent feeding hole 30 on the second metal radiating units 22 and the center of the first metal radiating unit 21, is 90 degrees.

As shown in FIGS. 1-7, the connecting line between the feeding hole 30 on the first metal radiating unit 21 and the center of the first metal radiating unit 21 and the connecting line between the feeding hole 30 on the second metal radiating unit 22 and the center of the first metal radiating unit 21 are overlapped with each other or arranged at an included angle of 45°.

In another embodiment of the present invention, as shown in FIGS. 1-7, a third metal radiating unit 60 is disposed around the second metal radiating unit 22, and a second non-metallized isolating region 50 is disposed between the second metal radiating unit 22 and the third metal radiating unit 60. The second non-metallized isolating region 50 is provided with a plurality of second metallized coupling bridges 51, the two ends of the second metallized coupling bridge 51 are respectively electrically connected with the second metal radiating unit 22 and the third metal radiating unit 60.

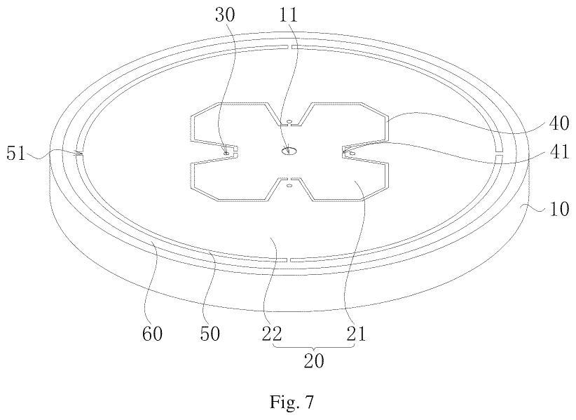

In another embodiment of the present invention, as shown in FIG. 7, the third metal radiating unit 60 and the second non-metallized isolating region 50 are symmetrically arranged with the center of the first metal radiating unit 21.

In another embodiment of the present invention, as shown in FIGS. 1-7, the substrate plate 10 and the first metal radiating unit 21 are both provided with metallized central through holes 11 which can be aligned and communicated with each other, and the central through holes 11 are electrically connected to the back surface of the substrate plate 10 by metallized grounding or PCB grounding.

In another embodiment of the present invention, as shown in FIGS. 1-3 and FIG. 6, the substrate plate 10 is provided with a plurality of metallized grounding holes 12, and each of the metallized grounding holes 12 is disposed around the GNSS antenna assembly 20. The metallized ground hole 12 is electrically connected with the back surface of the substrate plate 10 by metallized grounding or PCB grounding.

In another embodiment of the present invention, as shown in FIGS. 1-3 and FIG. 6, the metallized grounding hole 12 extends to form a metallized grounding down-conversion branch 13, which is located on the substrate plate 10 for down-conversion processing of the GNSS antenna assembly 20.

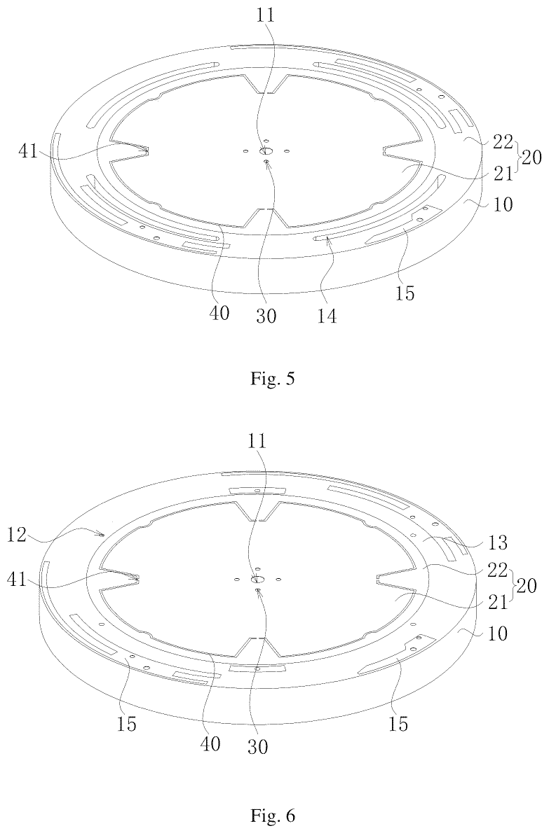

In another embodiment of the present invention, as shown in FIGS. 5-7, a plurality of communication antennas 15 are disposed on the periphery of the metallized grounding down-conversion branch 13.

In another embodiment of the present invention, as shown in FIGS. 4-5, the periphery of the GNSS antenna assembly 20 is provided with a plurality of metallized isolating grooves 14, which are electrically connected to the back surface of the substrate plate 10 by metallized grounding or PCB grounding. The shape of the substrate plate 10 can be configured in a circular or polygonal shape depending on the user's needs.

The above Description is only preferred embodiments of the present invention and is not intended to limit the present invention. Any modifications, equivalent replacements and improvements made within the spirit and principle of the present invention shall fall within the protection scope of the present invention.

What is claimed is:

1. A single-substrate coplanar coupling wide-band high-accuracy positioning combined antenna, comprising a substrate plate, a GNSS antenna assembly attached to a surface of said substrate plate, and multiple feeding holes; said GNSS antenna assembly includes a first metal radiating unit and a second metal radiating unit surrounding said first metal radiating unit; a first non-metallized isolating region is provided between said first metal radiating unit and said second metal radiating unit; said first non-metallized isolating region is provided with multiple first metallized coupling bridges; two ends of each first metallized coupling bridge are electrically connected to said first metal radiating unit and said second metal radiating unit, respectively; said first metal radiating unit, said second metal radiating unit, said first non-metalized isolating region, and said multiple first metallized coupling bridges are all arranged symmetrically around a center of said first metal radiating unit.

2. The single-substrate coplanar coupling wide-band high-accuracy positioning combined antenna according to claim 1, wherein each feeding hole is positioned on either said first metal radiating unit or said second metal radiating unit for outputting both high frequency and low frequency coupling signals from said GNSS.

3. The single-substrate coplanar coupling wide-band high-accuracy positioning combined antenna according to claim 1, wherein said first metal radiation unit and said second metal radiation unit are both provided with multiple feeding holes for outputting GNSS high-frequency or low-frequency coupling signals.

4. The single-substrate coplanar coupling wide-band high-accuracy positioning combined antenna according to claim 1, wherein a third metal radiating unit is disposed around said second metal radiating unit, and a second non-metallized isolating region is disposed between said second metal radiating unit and said third metal radiating unit; said second non-metallized isolating region is provided with multiple second metallized coupling bridges, two ends of each second metallized coupling bridge are electrically connected with said second metal radiating unit and said third metal radiating unit, respectively.

5. The single-substrate coplanar coupling wide-band high-accuracy positioning combined antenna according to claim 4, wherein said third metal radiating unit and said second non-metallized isolating region are symmetrically arranged with a center of said first metal radiating unit.

6. The single-substrate coplanar coupling wide-band high-accuracy positioning combined antenna according to claim 1, wherein said substrate plate and said first metal radiating unit are both equipped with metallized central through holes which can be aligned and communicated with each other, and said metallized central through holes are electrically connected to a back surface of said substrate plate by metallized grounding or PCB grounding.

7. The single-substrate coplanar coupling wide-band high-accuracy positioning combined antenna according to claim 1, wherein said substrate plate is provided with multiple metallized grounding holes, and each of said metallized grounding holes is disposed around said GNSS antenna assembly; each metallized ground hole is electrically connected with a back surface of said substrate plate via metallized grounding or PCB grounding.

8. The single-substrate coplanar coupling wide-band high-accuracy positioning combined antenna according to claim 7, wherein said metallized grounding hole extends to form a metallized grounding down-conversion branch, which is located on said substrate plate for down-conversion processing of said GNSS antenna assembly.

9. The single-substrate coplanar coupling wide-band high-accuracy positioning combined antenna according to claim 8, wherein multiple mobile communication antennas are strategically distributed around said metallized grounding down-conversion branch.

10. The single-substrate coplanar coupling wide-band high-accuracy positioning combined antenna according to claim 1, wherein multiple metallized isolating grooves are strategically positioned around GNSS antenna assembly and are electrically connected to the bottom surface of the substrate plate.
